(19) United States
(12) Patent Application Publication
(10) Pub. No.: US 2008/0278642 A1
(43) Pub. Date: Nov. 13, 2008

(54) Light-Control Elements and Materials

(75) Inventors: Hiroaki Miura, Kamakura-shi (JP); Hidekazu Takahashi, Hodogaya-ku (JP); Yuichiro Okada, Yokosuka-shi (JP)

Correspondence Address: GLOBAL IP COUNSELORS, LLP, 1233 20TH STREET, NW, SUITE 700, WASHINGTON, DC, 20036-2680, US

(73) Assignee: Nissan Motor Co., Yokohama-shi (JP)

(21) Appl. No.: 10/572,858

(22) PCT Filed: Oct. 27, 2005
(86) PCT No.: PCT/IB05/03212

§ 371 Date: Mar. 22, 2006

(30) Foreign Application Priority Data
Oct. 27, 2004 (JP) 2004-312900

(51) Int. Cl. G02F 1/1335; B32B 3/00; B44C 3/08

(52) U.S. Cl. 349/16; 428/156; 156/219

(57) ABSTRACT

The disclosure relates to a light-control element including a transparent surface layer oriented in an uniaxial direction, a center layer comprising a skeletal member and a plurality of cavities arranged at intervals and oriented parallel to the uniaxial direction of the surface layer, and a base layer. In some embodiments, the light-control element includes a liquid crystal material at least partially filling the cavities. In certain preferred embodiments, each of the surface layer and the base layer include one or more electrodes adapted for application of an electrical potential to the liquid crystal material. The disclosure also provides methods of manufacturing and using light control window glazings including light-control elements containing liquid crystal materials for efficient thermal management of interior spaces of vehicles and buildings.

### TECHNICAL FIELD

The invention relates to light-control materials and methods of manufacturing and using light control window glazings suitable for efficient thermal management of interior spaces of vehicles and buildings.

### BACKGROUND

Liquid crystal materials contain a crystalline phase dispersed in a polymeric fluid matrix, wherein the arrangement of the crystalline phase may be altered by applying a voltage to the fluid, and the nature of light transmittance is altered based on the arrangement of the liquid crystals. When a voltage is applied to the LC material, the liquid crystals dispersed in the polymeric fluid align in the direction of the external electric field. If the external electric field is oriented vertically and the refractive indices of the liquid crystal and the polymer are selected to closely match each other, then vertically polarized visible light entering the LC element will be transmitted without reflecting at the boundary between the liquid crystal and the polymer, and the LC material becomes optically transparent to vertically polarized light. When the application of voltage is ceased, the crystalline phase becomes randomly ordered, and the LC material appears opaque.

In practice, the majority of light entering the LC material is randomly polarized, and is therefore scattered at the side opposite from the incident side even when a voltage is not applied to the LC material. Consequently, sunlight transmittance is barely reduced compared to the transmittance obtained upon application of a voltage to the LC material. As a result, a large quantity of solar radiation energy enters the interior region of a building or a vehicle, which tends to raise the temperature of the interior space even when a voltage is not applied to the LC material. Improvements are thus required to create practical LC light-control materials and light-control elements for use in thermal management window glazings separating the interior and exterior regions of a vehicle or building. The art thus continues to search for new and improved light control materials and for methods of making and using more effective light control window glazing materials.

### SUMMARY

In general, the invention relates to light-control materials and methods of manufacturing and using light control window glazings containing liquid crystal materials for efficient thermal management of interior spaces of vehicles and buildings.

In one aspect, the invention provides a light-control material including a surface layer oriented in an uniaxial direction, a center layer including a skeletal member, and a base layer. In some presently preferred embodiments, the light-control material includes a liquid crystal material at least partially filling the center member. In certain presently preferred embodiments, one or both of the surface layer and base layer are substantially transparent to visible light. Each of the surface layer and the base layer preferably include one or more electrodes adapted for application of an electrical potential to the liquid crystal material.

In another aspect, the invention relates to a method of manufacturing a light-control material that includes a step wherein a transparent surface layer oriented in an uniaxial direction and a center layer are laminated to form an optical structure, a step wherein the optical structure is laminated to a transparent base layer; and a step wherein a liquid crystal material is added to the cavities. The center layer preferably includes a skeletal member and a plurality of cavities members arranged at intervals and oriented parallel to the uniaxial direction of the surface layer at the time of lamination. Lamination is preferably achieved with a nano-imprinting method to form the optical structure.

In another aspect, the invention relates to a vehicle having window glazing containing a light control element including a surface layer oriented in an uniaxial direction, a center layer comprising a skeletal member and a plurality of cavities arranged at intervals and oriented parallel to the uniaxial direction of the surface layer, a base layer, and a liquid crystal material at least partially filling the cavities. The light-control elements are particularly useful, for example, as windshield glass, sunroof glass, and front side window glass of vehicles.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 illustrates a cross-sectional view of an embodiment of a light-control material.

FIG. 2 illustrates a perspective view of an embodiment of a light-control material.

FIG. 3 illustrates a perspective view of a structure wherein rectangular-shaped skeletal members are arranged in parallel.

FIG. 4 illustrates a perspective view of a structure wherein the skeletal members are arranged in parallel in both the horizontal direction (direction shown by the arrow in the figure) and the vertical direction.

FIG. 5 illustrates a perspective view of a structure wherein the skeletal member is arranged in the horizontal direction and the skeletal member is arranged in a zig-zag fashion in the vertical direction.

FIG. 6 illustrates a perspective view of a rectangular-shaped skeletal member.

FIG. 7 illustrates a perspective view of a barrel-shaped skeletal member.

FIG. 8 illustrates a perspective view of a triangular-shaped skeletal member.

FIG. 9 illustrates a perspective view of a trapezoid-shaped skeletal member.

FIG. 10 illustrates a perspective view of a structure where the structure is laminated with the axis in a twisted state.

FIG. 11 illustrates a perspective view of a structure where the structure is laminated with the axis in a twisted state.

FIG. 12 illustrates a perspective view that shows the height T of one of the structures.

FIG. 13 illustrates a schematic cross-section view of a light-control material containing a liquid crystal material positioned between electrodes.

FIG. 14 illustrates a perspective view that shows the change in the liquid crystal state at the time of application of voltage when the dielectric anisotropy of the liquid crystal material used to fill the cavity is positive.

FIG. 15 illustrates a perspective view that shows the change in liquid crystal state at the time of voltage application when the dielectric anisotropy of the liquid crystal used to fill the cavity is negative.

FIG. 16 illustrates a schematic view of an exemplary Skyline V35™ motor vehicle having light-control glazing material.

FIG. 17 illustrates a schematic view of an exemplary March K12™ motor vehicle having light-control glazing material.

FIG. 18 illustrates a schematic view of an exemplary Selena C24™ motor vehicle having light-control glazing material.

FIG. 19 illustrates a schematic view of an exemplary Primera Wagon WP11™ motor vehicle having light-control glazing material.

FIG. 20 illustrates a schematic view of an exemplary Fair Lady Z33™ motor vehicle having light-control glazing material.

FIG. 21 illustrates a schematic view of an exemplary manufacturing method for a first light control material.

FIG. 22 illustrates a schematic view of an exemplary manufacturing method for a second light control material.

FIG. 23 illustrates a schematic view of an exemplary device useful for the nano-imprinting process.

FIG. 24 illustrates a schematic view of the exemplary device useful for the nano-imprinting process wherein a die is arranged on an upper stage and a resin base material is arranged on a lower stage.

FIG. 25 illustrates a schematic view of the exemplary device useful for the nano-imprinting process wherein the upper stage is lowered and the first die is pressed against the resin base material.

FIG. 26 illustrates a schematic view of the exemplary device useful for the nano-imprinting process wherein the upper stage is raised forming a light-control structure having a skeletal member and a cavity arranged at pre-determined intervals and oriented in at least an uniaxial direction.

FIG. 27 illustrates a schematic view of the exemplary device useful for the nano-imprinting process wherein a second die arranged on the upper stage is filled with a resin.

FIG. 28 illustrates an exemplary time-temperature chart of the resin at the time of production of the light-control structure.

FIG. 29 illustrates an exemplary perspective view that shows the position of the temperature measurement used to obtain the time-temperature chart of FIG. 28.

FIG. 30 illustrates a schematic view of an exemplary device useful for evaluation of the temperature inside a vehicle under intense sunlight.

### DETAILED DESCRIPTION

The disclosure relates to light-control materials and light control elements containing liquid crystal (LC) materials, and methods of manufacturing and using light control window glazings containing liquid crystal materials for efficient thermal management of interior spaces of vehicles and buildings. In particular, the disclosure relates to nematic LC light-control elements having a curved polymer wall containing the crystalline phase, and LC elements produced by a phase separation method. Nematic LC elements, wherein a small droplet of a LC material is dispersed in an inexpensive polymer, may be prepared by arranging the LC along the curved path of the polymer wall under a condition where no voltage is applied. In this case, the optical path is twisted and furthermore, because light is reflected at the boundary between the curved polymer wall and the liquid crystal droplet, the LC element appears cloudy or milky even under conditions when a voltage is applied to the LC material. Properties desired for a nematic LC light-control material can be improved according to some embodiments of a light-control material having the structure of the present invention.

In some embodiments, the invention provides a light-control material having superior optical properties. In other embodiments, the invention provides a light-control material including a transparent surface layer oriented in an uniaxial direction, a center layer including a skeletal member and a plurality of cavities arranged at intervals and oriented parallel to the uniaxial direction of the surface layer, and a base layer. In some presently preferred embodiments, the light-control material includes a liquid crystal material at least partially filling the cavities. In certain presently preferred embodiments, each of the surface layer and the base layer include one or more electrodes adapted for application of an electrical potential to the liquid crystal material.

In other embodiments, the invention provides a method to increase the effectiveness of a light-control material containing a LC element and thereby increase the applicability of a light-control material containing the LC element to efficient thermal management of the interior spaces of vehicles or buildings. It should be noted that “light-control material” in the present invention means materials capable of changing the properties of the light that enters them. For specific examples of light-control materials, a light-control glass including a base material made of glass, and a light-control film comprising a base material made of a polymer film, and the like, are specifically included in the category of a light-control materials.

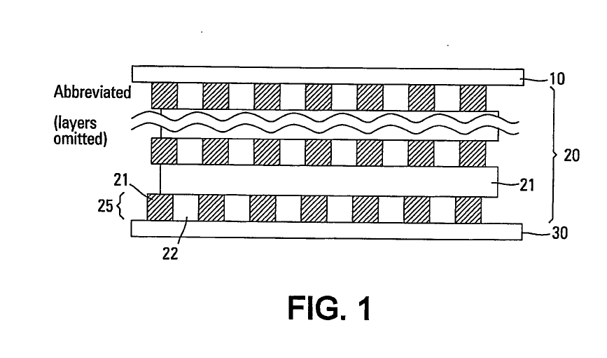

FIG. 1 is a schematic cross-section view of an embodiment of a light-control material according to the present disclosure. The light-control material 1 includes surface layer 10, center layer 20, and back layer 30. The center layer 20 has a structure 25 including skeletal members 21 and cavities 22 arranged at pre-determined intervals in at least a uniaxial direction. Furthermore, the cavity 22 is filled with a liquid crystal. The lamination direction of the structure 25 in this embodiment is, in order, surface layer 10, center layer 20, and back layer 30. The lamination direction of the surface layer 10, center layer 20, and back layer 30 is hereinafter simply referred to as the “lamination direction.” Furthermore, the direction perpendicular to the lamination direction is hereinafter referred to as “plane direction.”

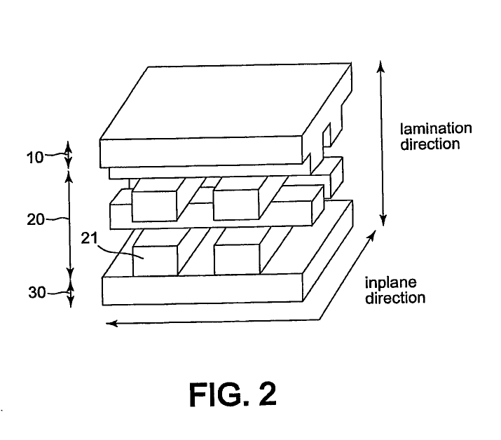

FIG. 2 is a perspective view of an embodiment of a light-control material. To make the explanation simple, an embodiment where a structure of four layers is laminated is used as an example, but the actual number of laminations and the thickness of the structure is not so limited. In general, compared to the surface layer 10 and back layer 30, the structure is very thin. The structure that forms the center layer has reflectivity for a certain wavelength determined by the structure arranged at a predetermined intervals and the index of refraction of the liquid crystal.

The term “skeletal member” refers to positions in the center layer where an object is arranged at a predetermined interval, while the term “cavity” refers to areas of the center layer without skeletal members. The cavities are filled with a liquid crystal material. In the light-control material of the present invention, the skeletal member and cavities are arranged at pre-determined intervals at least in a uniaxial direction. The “uniaxial direction” means at least one direction in the plane where skeletal member is arranged. In other words, when the skeletal member and cavities are arranged at pre-determined intervals in either direction of the plane, the requirement of the present invention is met. The “pre-determined interval” in this case means substantially pre-determined interval and variations that occur during the course of production may be included as long as the degree is insignificant.

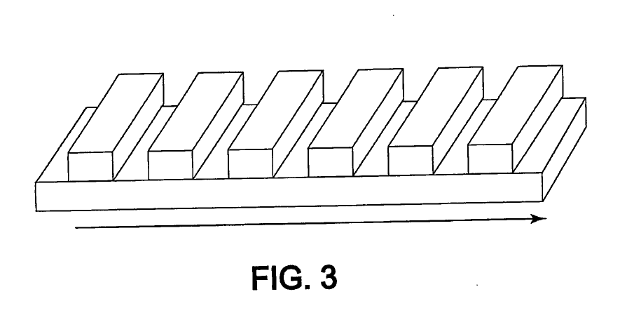

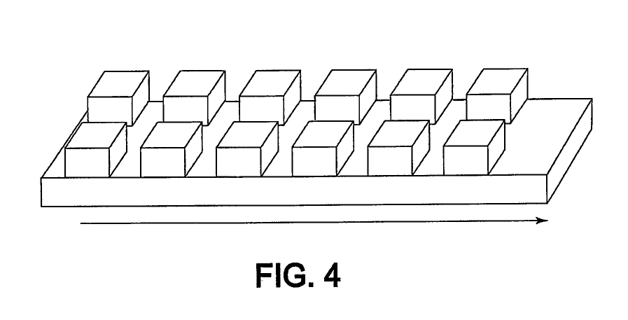

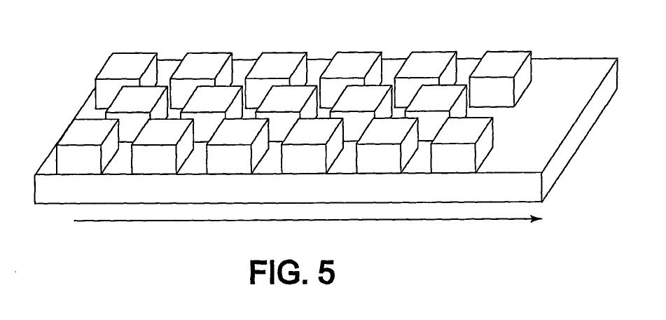

The structures shown in FIGS. 3-5 provide examples of suitable arrangements of the skeletal member and cavity according to some embodiments of the invention. FIG. 3 shows a structure where rectangular parallel-piped skeletal members are arranged in parallel. FIG. 4 is a structure where the skeletal members are arranged in two directions, horizontally (the direction indicated by the arrow in FIG. 4) and vertically. The structure shown in FIG. 4 can be a structure where the rectangular parallelepipeds shown in FIG. 3 are separated in the direction perpendicular to the arranged direction as well. FIG. 5 shows a structure where the skeletal member is arranged in the horizontal direction and arranged in a zig-zag fashion in the vertical direction.

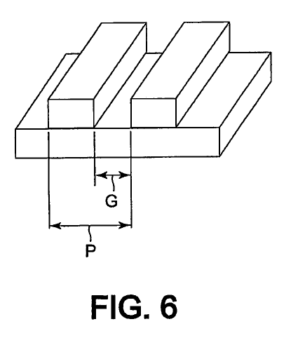

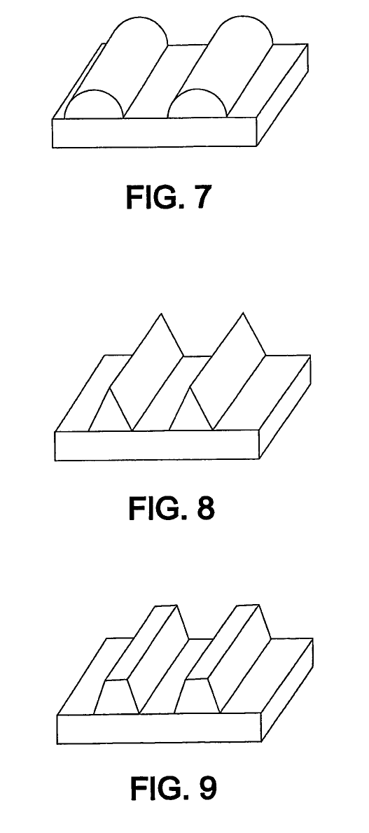

The shape of the skeletal member may vary widely depending on the intended application. In FIGS. 2-5, examples illustrate a cross-section of the skeletal member as a tandem shape, but this shape is not especially limited as long as it permits three-dimensional lamination of the light-control material. In addition to a rectangular parallel-piped (FIG. 6), for example, barrel-shaped (FIG. 7), triangular shaped (FIG. 8), trapezoidal shaped (FIG. 9), and like structures are suitable for use in embodiments of the invention.

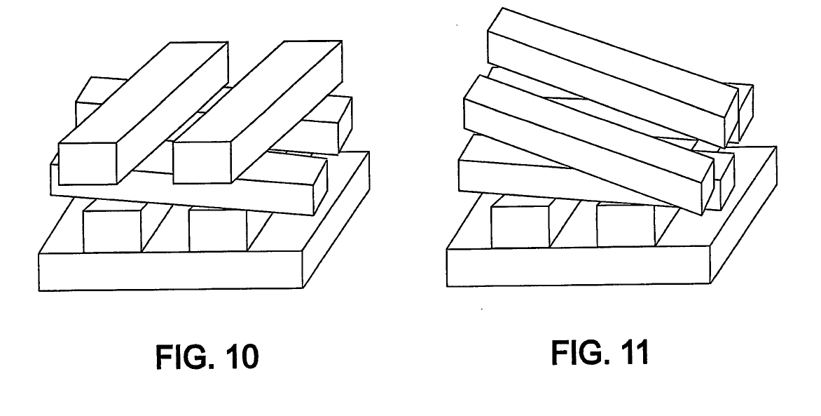

It is not necessary for the lamination structure to form a right angle as shown in FIG. 2 and reflectivity can be achieved when periodicity exists in the inplane structure even when the axis has a twisted structure as shown in FIG. 10 and FIG. 11.

The size and arrangement of the skeletal member and cavity may be determined taking optical performance parameters such as reflectivity and transmittance into consideration. In specific terms, the ratio of length:pitch of the cavity in the structure is in the range of about 1:1 to 1:40. The length of cavity means the length of the cavity in the direction where the skeletal member and cavities are arranged at a pre-determined interval, such as the length shown by G in FIG. 6. The pitch means the length of the repeated unit including a skeletal member and a cavity in the direction where the skeletal member and cavity are arranged at pre-determined intervals, such as the length indicated by P in FIG. 6.

The length of the cavity is preferably in the range of 50-400 nm. Furthermore, the width of the pitch is preferably in the range of 100-800 nm. These ranges are particularly suitable for light-control in the visible light region and near infrared region, which allows for control of energy transmission and reflection for buildings and vehicles. For example, when the refraction of the liquid crystal is set between approximately 1.3 and 1.9, preferred refraction of the structure is set between approximately 1.2 and 1.6, since the preferred difference between the refraction of the liquid crystal and the refraction of the refraction of the structure be more than 0.05, preferably more than 0.2, which is calculated with the following formula:

λ=2P×(2/3×(nₐ²−sin²θ))^{1/2},

nₐ=nₗ²×f+nₛ²×(1−f)

λ: reflection wavelength

P: length of the repeated unit including a skeletal member and cavity

nₐ: average refraction index

nₗ: refraction index of liquid crystal

nₛ: refraction index of skeletal member

f: proportion the volume of liquid crystal to the volume of center layer

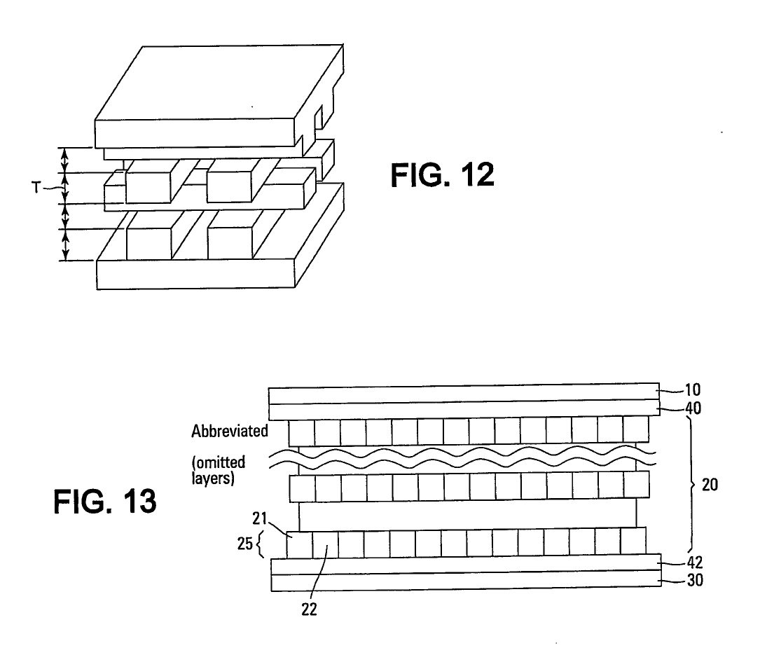

It is preferred that the height per period of the in-plane structure in the thickness direction cut for each plane be approximately 50-800 mm. The height per period means the height of one structure of the laminated structure, and corresponds to the length shown by T in FIG. 12. When the value of height per period is in this preferred range, periodicity can be provided for the thickness direction as well, and in some embodiments the structure may provide increased reflectivity.

Suitable materials for constructing the skeletal member include silica (SiO₂), radiation curable resins, all-purpose resin materials, and the like. Preferred all-purpose resin materials include thermoplastic resins. Suitable thermoplastic resin materials include aliphatic polyamides such as nylon 66; polyesters such as polyethylene terephthalate (PET); polyphenylene sulfide (PPS); polyether ether ketone (PEEK); polypropylene (PP); polymethyl methacrylate (PEA); polylactate, and the like. The use of thermoplastic resin materials is preferred from the standpoint of processability, cost, commercial availability, recyclability, and the like.

The cavity may be filled with a liquid crystal. The liquid crystal material used in this case may vary widely depending on the intended application, and it is preferred that the nematic-isotropic transition temperature (NI point) lies in a normal temperature range. Furthermore, when the liquid crystal used in the present invention is a liquid crystal having dielectric anisotropy, either one of normal index of refraction or abnormal index of refraction undergoes an arrangement as a result of conditions such as temperature, light, and application of voltage. This allows the index of refraction of the other components in the structure and functions such as change in reflectivity can also be made.

It is desirable for the liquid crystal used to fill the cavity to form an isotropic phase. In the present specification, the term “to form an isotropic phase” means forming of an isotropic phase without a special external factor such as voltage. It is further desirable that a liquid crystal capable of forming an isotropic phase at normal temperatures be used. In this case, the term “normal temperature” means the temperature range where the light-control materials are commonly used, and typically the normal temperature is about 20° C. to 40° C. In the present specification, the term “isotropic phase” means the complex or mixture of liquid crystal molecules that exhibit liquid crystallinity have an absence of orientation. This is to be contrasted with the “liquid crystal state” where the molecules are oriented in a specific direction.

In one aspect, the present disclosure is directed to liquid crystal materials having specific functionality in the isotropic state. When a liquid crystal with an isotropic phase is used, many different effects can be achieved. However, it should be especially noted that the scope and technical range of the present invention is not limited to light-control materials exhibiting any or all of the effects described below.

In certain embodiments, it is possible to reflect sunlight and to reduce transmittance of solar radiation energy when transmission of the solar radiation energy inside the windows of vehicles parked under a hot sun or inside buildings exposed to direct sunlight. This may provide an improved vehicular or room environment and a reduction in the cooling load. When a liquid crystal material having an isotropic phase is used, it is also reliable. If mechanical breakdown of a vehicle occurs and application of voltage to the liquid crystal is interrupted due to failure of the battery, alternator, engine or other energy generation or storage devices in the vehicle, the translucence of the glass can be maintained. And problems such as an inability to see ahead due to an accident or mechanical failure of the vehicle's energy generation or storage devices can be avoided.

When a liquid crystal having an isotropic phase is used, sufficient visible light transmittance can be achieved. For example, under current Japanese law, it is necessary for the visible light transmittance of the glass (Tᵥ) used for the front windshield of a vehicle to be at least 70%. According to some embodiments of the present invention, it is possible to meet or exceed the Japanese visual light transmittance standard.

However, the technical range of the light-control material of the present invention and products applied are not limited to those with a visible light transmittance of at least 70%. For example, the present invention can be applied to applications where visibility of at least 70% is not required for glass used for buildings, and, for example, the light-control material described herein may be used for the this purpose. Furthermore, when a liquid crystal having an isotropic phase is used, problems based on angular dependency, where the glass appears transparent from the front but is not transparent when observed from a different angle, can typically be substantially reduced or eliminated as well.

For the liquid crystal molecule used in the present invention, in addition to benzene rings, cyclohexane rings, cyclohexene rings, and the like, those where 2-4 cyclic compounds are bonded, for example, hetero rings such as pyrimidine rings, dioxane rings, and pyridine rings can be used. For the bonding member, an ester bond referred to as a “mesogene” group, an acetylene bond (alkynyl group), an ethylene bond (alkenyl group), an azo bond, and the like can be used. For the end group and substituents of side groups, cyano group, fluoro group, alkyl group, alkenyl group, alkoxy group, etc. can be used. For example, azoxy type, biphenyl type, phenyl cyclohexane type, phenyl ester type, cyclohexane phenyl ester carboxylate type, phenyl pyrimidine type, phenyl dioxane type liquid crystals, and the like can be used. These liquid crystal materials can be used alone or as a mixture or a combination thereof, and mixtures of two or more materials is suitable for many applications. In the present invention, a single liquid crystal material or a mixture of liquid crystal molecules is referred to as a liquid crystal.

The liquid crystal materials are preferably prepared such that an isotropic phase can be achieved at normal temperatures. Specific examples of liquid crystal molecules capable of forming an isotropic phase at normal temperatures include, for example, 4-pentyl-4-cyano phenyl (5CB), 4-hexyl-4′-cyanobiphenyl (6CB), 4-hexyl-4′-cyano phenyl pyridine, 4-hexyl-4′-propyl phenyl cyclohexane, 4-methyl-4′-propyl dicyclohexane, 4-hexyl-4′-methoxy dicyclohexane, and the like.

To provide an isotropic phase to the liquid crystal, a material capable of forming an isotropic phase with the liquid crystal materials may be used or an isotropic phase may be provided by mixing a variety of liquid crystal materials. Furthermore, an isotropic phase may be provided for the liquid crystal with a dispersing material. If the isotropic phase is provided by dispersing material, it is possible to form an isotropic phase over a wide temperature range. Therefore, it is effective when used for a wide range of operational temperatures as is preferred for applications in automobiles. For example, a dispersing material such as flexing type molecule can be used. Specific examples of dispersing agents that can be used include, as with the liquid crystals, those having a cis-ethylene group and a hydrogen in the cis-ethylene group that is substituted with a halogen group such as fluoro group or bromo group, a cis-azo group, etc. in the backbone.

The filled liquid crystal is preferably a liquid crystal having an isotropic phase transition temperature in the range of −40° C. to 40° C. and forms an isotropic phase at a temperature above the isotropic phase transition temperature. A lower isotropic phase transition temperature is preferred, but materials with an isotropic phase transition temperature in the range of −40° C. to 40° C. are useful for most applications.

To reduce visible light transmittance based on a change in the center layer, temperature, light, voltage applied, etc. are used according to the type of liquid crystal used and arrangement of the liquid crystal molecules. For example, arrangement of the liquid crystal is achieved through application of voltage. In this case, the “arrangement of the liquid crystal molecule” means that the liquid crystal molecule responds to the electric field generated at the time of application of the voltage and is provided with order and the liquid crystal molecule is arranged orthogonally or in parallel to the electric field. As long as the arrangement of the liquid crystal molecules is achieved, the waveform of the voltage applied is not especially limited.

To apply a voltage, a pair of electrodes is arranged on the surface layer and back layer, and a liquid crystal is arranged between the surface layer and back layer. FIG. 13 shows a schematic cross-section view of a light-control material having a surface layer 10 and back layer 30 provided with a pair of electrodes (40 and 42), and center layer 20 containing a liquid crystal is arranged between the electrodes 40 and 42. In this case, it is desirable that the electrode be transparent. Use of the surface layer 10 and back layer 30 as positive side or negative side is not especially limited as long as one of positive electrode or negative electrode is arranged on surface layer 10 and back layer 30 and application of voltage to the liquid crystal included in the center layer 20 is possible. The liquid crystal forms the isotropic phase when current is applied, and forms an arrangement phase when current is absent. In this manner, visible light transmittance is insured at the time of absence of current application and light-control functions based on the arrangement can be achieved at the time of current application.

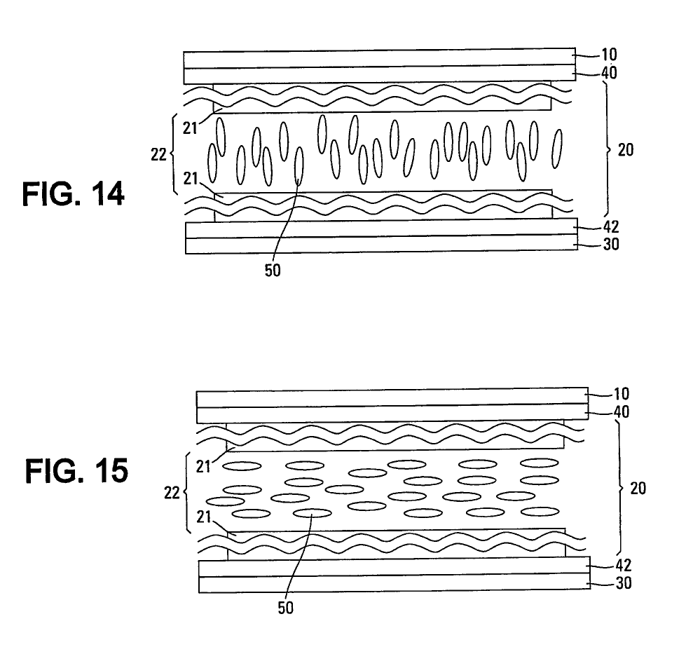

FIG. 14 is a diagram that shows the change in the liquid crystal state at the time of application of voltage when the dielectric anisotropy of the liquid crystal 50 used to fill the cavity 22 is positive. FIG. 15 is a diagram that shows the change in liquid crystal state at the time of voltage application when the dielectric anisotropy of the liquid crystal 50 used to fill the cavity 22 is negative. When the liquid crystal is controlled as shown in FIG. 14 and FIG. 15, a change in index of refraction of the liquid crystal can be achieved, as well as desired level of reflectivity and transmittance.

The voltage applied at the time of application of voltage for arrangement of the liquid crystal is determined according to the thickness of the center layer 20 and type of liquid crystal molecule used and is not especially limited, and in this case, approximately 3-200 V is suitable.

The surface layer 10 and back layer 30 are transparent materials. In the present specification, “transparent” means a light transmittance of at least 70%. The surface layer 10 and back layer 30 include a transparent resin, glass, etc. As long as transparency is insured, surface layer 10 and back layer 30 may be colorless or tinted. It should be noted that the surface layer 10 means the layer arranged on the light source side, and the back layer 30 means the layer on the opposite side from the light source, but no strict distinction is required. For example, when the same material is used for the surface layer 10 and back layer 30, either side may be used as the surface layer.

The size and thickness of the surface layer 10 and back layer 30 are determined according to the intended use of the light-control material. For example, when the light-control material is used for the windshield glass of automobiles, the size of the surface layer 10 and back layer 30 is determined according to the design of the vehicle. Furthermore, the thickness is determined taking the transmittance and strength of the light-control material into consideration.

The glass material used for the surface layer 10 and back layer 30 is not especially limited. The glass may be colorless or tinted. Suitable materials include, for example, clear glass, green glass, bronze glass, gray glass, blue glass, UV-cutting insulating glass, heat absorbing glass, reinforced glass, and the like. Combinations of these glasses may also be used.

The resin material used for the surface layer 10 and back layer 30 is not especially limited and resins commonly used can be used in this case as well. The resin may be either a thermoplastic resin or a thermosetting resin. For increased range of applications, thermoplastic resins are desirable. In specific terms, aliphatic polyamides such as nylon 66; polyesters such as polyethylene terephthalate (PET); polyphenylene sulfide (PPS); polyether ether ketone; polypropylene (PP); etc. can be mentioned and use of these materials is desirable from the standpoint of processability, economy, availability, recyclability, etc. Among those listed above, polypropylene and polyester are especially desirable and for example, for polyesters, polyethylene terephthalate (PET), polybutyrene terephthalate (PBT), polyethylene naphthalate (PEN), polybutyrene naphthalate (PBN), polyethylene isophthalate (PEI), polybutyrene isophthalate (PBI), poly-∈-caprolactone (PCL), etc., and furthermore, those where the ethylene glycol component in PET is substituted with a different glycol component (for example, polyhexamethylene terephthalate (PHT)), those where the terephthalic acid component is replaced with a different dibasic acid component (for example, polyhexamethylene isophthalate (PHI), polyhexamethylene naphthalate (PHN)), etc. can be mentioned.

The surface layer 10 and back layer 30 may be resin films. When the surface layer and back layer are resin films, a thin film-like light-control material can be produced. These film-like materials may be used as partitions and interior materials, and the like.

It is desirable when the film-like light-control material and glass are integrated and used as a transparent light-control glass as well. In some embodiments, production of light-control glass utilizing a film-like light-control material as described in this disclosure is simplified. For example, upon formation of a center layer comprising a liquid crystal between two glass sheet layers, filling of the liquid crystal between the two glass sheet layers is an inconvenient process. Instead of using this process, productivity can be improved when a film-like light-control material in which a liquid crystal material is filled between resin films is produced ahead of time and the film-like light-control material is inserted between glass sheets.

If the center layer includes a liquid crystal formed between resin films, a pair of transparent glasses may be arranged on the outer side of the surface layer and back layer including the resin film as described above. Furthermore, a transparent glass may be used for either one or the other of a surface layer and back layer including the resin films. This embodiment can be achieved by bonding a film-like liquid crystal element onto a glass sheet.

For resin materials that make up the surface layer 10 and back layer 30, in addition to the thermoplastic resins referred to above, polymers utilizing styrene, methyl methacrylate, acrylonitrile, polycarbonate, polybutadiene, polyethylene-2,6-naphthalate, tetraethylene glycol ether, etc. as monomers may be used. Furthermore, copolymers including two or more of these monomers may be used as well. For example, a copolymer of styrene and methyl methacrylate, a copolymer of styrene and acrylonitrile, a copolymer of styrene and butadiene, a copolymer of 4,4-thiodiphenol and bisphenol A, a copolymer of gluterimide and methyl methacrylate, can be used.

The light-control material described in this disclosure can be used for a variety of applications including, for example windshields and front side windows of vehicles. Japanese law requires the visible light transmittance (Tᵥ) of the solar radiation energy component be at least 70%. Windshields and front side windows utilizing the light-control material of the present invention sufficiently satisfy the visible light transmittance (Tᵥ) requirement, at least while driving, and is an effective means to reduce sunlight transmittance (Te) as well.

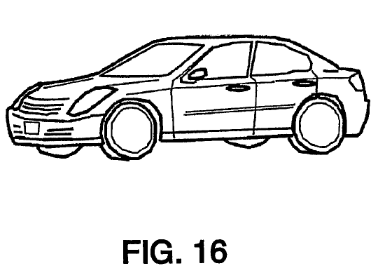

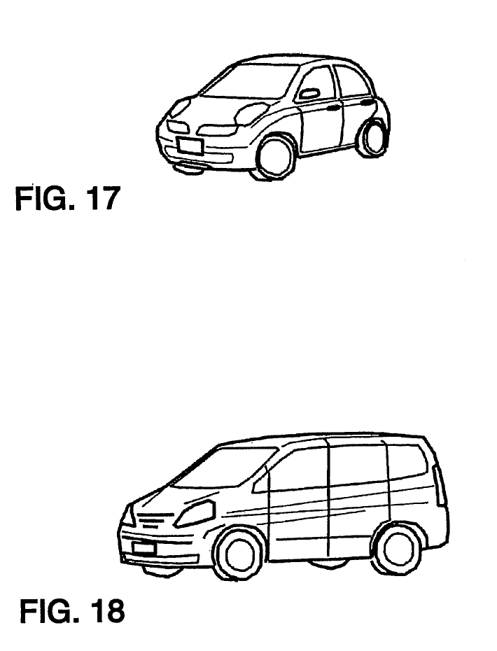

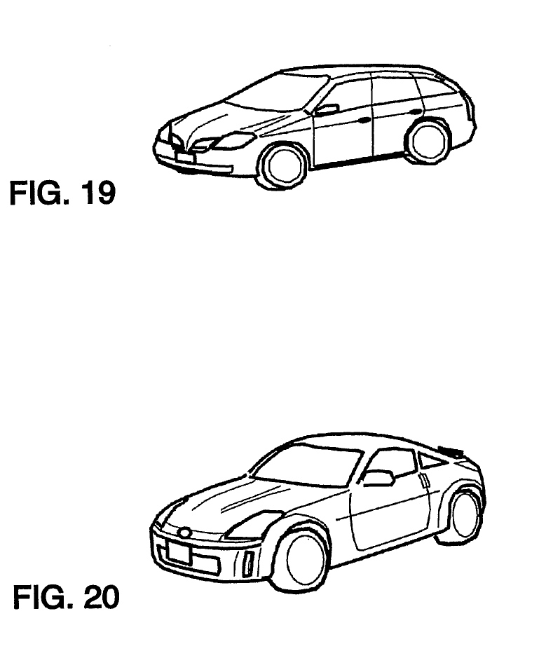

The light-control materials described in this disclosure can be applied to a variety of vehicles. For example, a sedan such as shown in FIG. 16 (available from Nissan Automobile Co., Ltd., under the trade designation Skyline V35), a compact car such as shown in FIG. 17 (available from Nissan Automobile Co., Ltd., under the trade designation March K12), a mini-van such as shown in FIG. 18 (available from Nissan Automobile Co., Ltd., under the trade designation Selena C24), a station wagon such as shown in FIG. 19 (available from Nissan Automobile Co., Ltd., under the trade designation Primera Wagon WP11), a sports car such as shown in FIG. 20 (available from Nissan Automobile Co., Ltd., under the trade designation Fair Lady 733), and the like. In addition, the light control materials may be used on other vehicles such as light cars, coupes, sport utility vehicles (SUVs), light trucks (e.g. those available from Nissan Automobile Co., Ltd., under the trade designation 1BOX and 2BOX), vans, aircraft, and boats. When applied to these vehicles, the light control materials save energy and prevent solar warming by controlling light and heat transmission into the vehicle interior.

In another aspect, the present invention relates to a method of manufacturing the inventive light-control material utilizing a nano-imprinting process. In some embodiments, the method includes a step wherein a light-control structure including a skeletal member and a plurality of cavities arranged at pre-determined intervals in at least an uniaxial direction is formed using a nano-imprinting process, a step wherein the light-control structure is laminated to a transparent surface layer and a transparent back layer, and a step wherein the cavities are filled with a liquid crystal material.

Suitable nano-imprinting methods include, for example, hot nano-embossing and radiation-cured nano-pattern imprinting methods. Suitable radiation curing methods include UV curing, electron beam curing, infrared curing and the like.

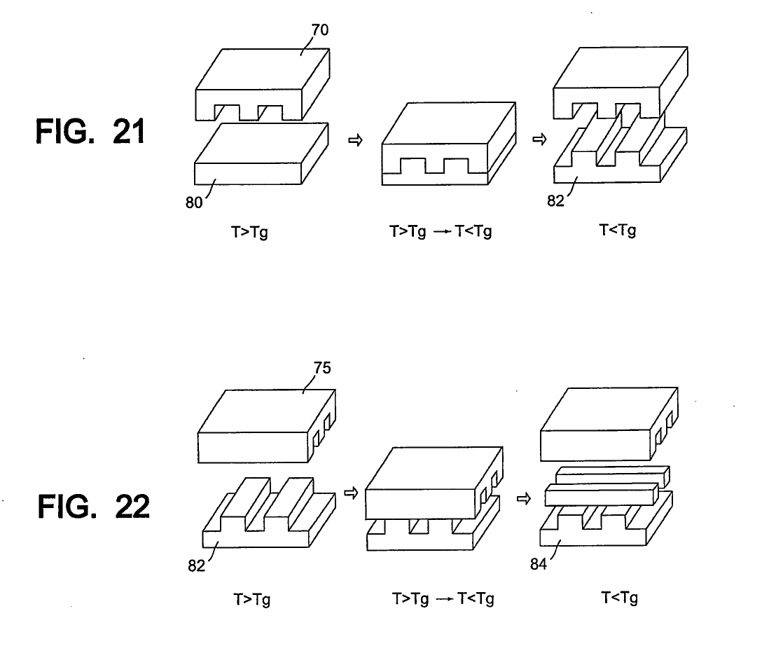

In the hot nano-embossing method, illustrated in FIG. 21, a die with a pre-determined shape is pressed against a resin layer and the die cuts into the resin layer to form a micro-pattern. In this case, first, the first die 70 is pressed against the resin base material 80. At this time, the temperature of the resin base material is increased to a temperature above the glass transition temperature of the resin. When the resin base material 80 is filled into the first die, the resin base material 80 is chilled and the temperature of the resin is reduced to a temperature below the glass transition temperature of the resin. When the resin is solidified, the first die 70 is pulled away from the resin base material 80 to produce a resin base material 82 having a pattern on the surface. The process from the second step on in producing the structure can be done according to the mechanism described in FIG. 2.

In production of the structure from the second step on, a resin is filled in the second die 75 ahead of time. The second die 75 filled with resin is brought into contact with the resin base material 82 having the surface provided with a pattern. The temperature of the resin is increased to a temperature above the glass transition temperature of the resin and the resin of resin base material 82 having the surface provided with a pattern and the resin filled in the second die 75 are bonded. Subsequently, the temperature of the resin is reduced to a temperature below the glass transition temperature. When the resin is solidified, the second die 75 is pulled away from resin base material 82 having the surface provided with a pattern to produce a resin base material 84 provided with a pattern.

In the radiation-cured nano-pattern imprinting method, radiation from a radiation source (e.g. UV, electron beam, infrared, or other actinic radiation) is applied to a radiation curable chemical compound such as a liquid radiation-curable monomer or resin as the radiation-curable chemical compound is being supplied to the die containing the nano-pattern, and curing is achieved. Upon selection of the particular radiation curing method, it is desirable to provide sufficient time and energy exposure of the radiation-curable material to the radiation source to cure the resin.

In some embodiments, the nano-imprinting method is useful to produce light-control material having a three-dimensional structure and a large surface area at a low cost. Among the variety of nano-imprinting methods, such as the hot nano-embossing method and radiation-cured nano-pattern imprinting method, the hot nano-embossing method is particularly preferred for ease of selecting the resin material used to form the optical structure. For example, relatively lower cost commercially available thermoplastic resins may generally be selected for use with hot nano-embossing, while higher cost specialty radiation-curable monomers or resins are generally required for use in practicing radiation-cured nano-pattern imprinting.

In specific terms, it is desirable when lamination of the structure includes a step where the first die heated to a temperature above the glass transition temperature of the resin is pressed against a base material including a resin to fill the first die with the resin, a step where the temperature of the first die is reduced to a temperature below the glass transition temperature of the resin, a step where the first die cooled to a temperature below the glass transition temperature of the resin is pulled away from the base material, a step where a structure comprising a skeletal member and cavity arranged at pre-determined intervals in at least a uniaxial direction is formed, a step where the second die filled with a resin that forms the skeletal member is pressed onto the structure, a step where the temperature of the resin filled in the second die is reduced to a temperature below the glass transition temperature of the resin, and a step where the second die is pulled away from the structure so as to form the second structure where a skeletal member and cavities are arranged at pre-determined intervals in at least a uniaxial direction.

An example of a device used for the nano-imprinting method is explained further with the attached drawings. However, it should be particularly noted that the scope of the present invention is not limited to the device described in the following examples.

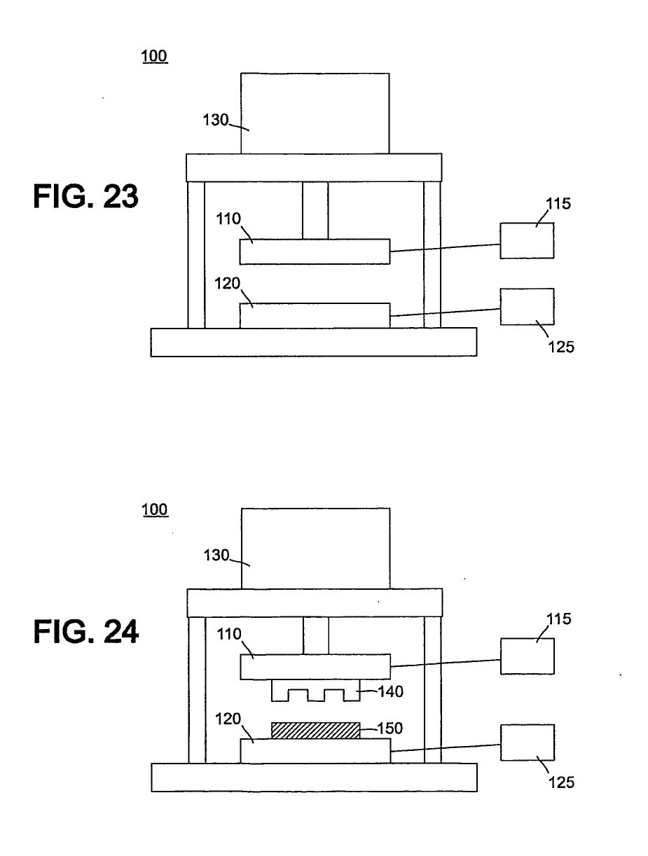

FIG. 23 is a schematic view of a device used for the nano-imprinting method. Upper stage 110 and lower stage. 120 are arranged inside nano-imprinting device 100, and the upper stage 110 and lower stage 120 are each provided with temperature control systems (115 and 125) for regulating the temperature of the resin arranged on each stage. Furthermore, the device is provided with pressure control system 130, and a given pressure is applied to the resin and die arranged between the stages. The method used for the temperature control system and pressure control system is not especially limited. For example, hydraulic pressure, air pressure, electrical control, etc. can be used.

FIG. 24 shows a schematic view where the first die 140 is arranged on the upper stage 110 and resin base material 150 is arranged on lower stage 120. The resin base material 150 arranged on the lower stage 120 is heated to a temperature above the glass transition temperature of the resin base material 150 by the temperature control system 125.

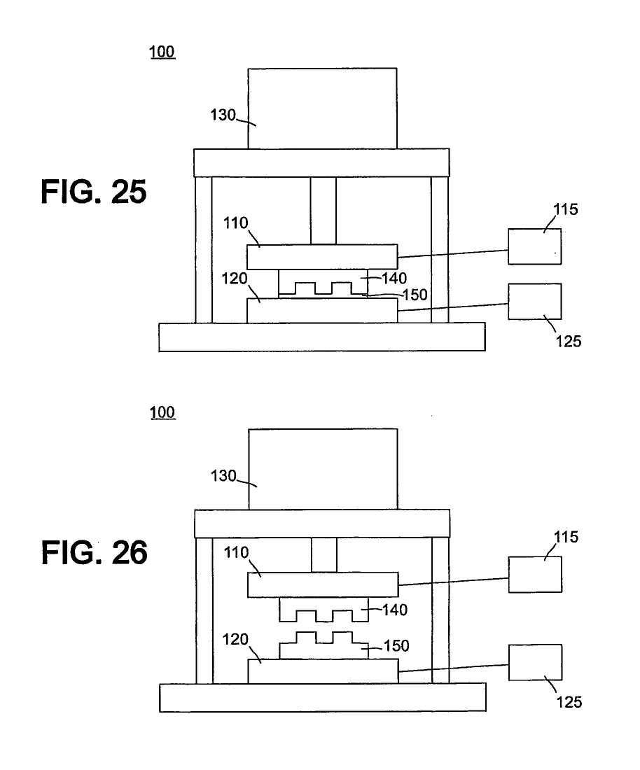

The upper stage 110 is lowered and the first die 140 is pressed against the heated resin base material 150. FIG. 25 is a schematic view that shows a state where the upper stage 110 is lowered and the first die 140 is pressed against the resin base material 150. When the resin is filled in the recessed member of the first die 140, the temperature of the upper stage 110 and/or lower stage 120 is reduced to a temperature below the glass transition temperature of the resin so as to solidify the resin.

Upon solidifying the resin, upper stage 110 is raised and the upper stage 110 is separated from the resin base material 150. FIG. 26 is a schematic view that shows the upper stage 110 raised and structure 160 where a skeletal member and cavity are arranged at pre-determined intervals in at least uniaxial direction.

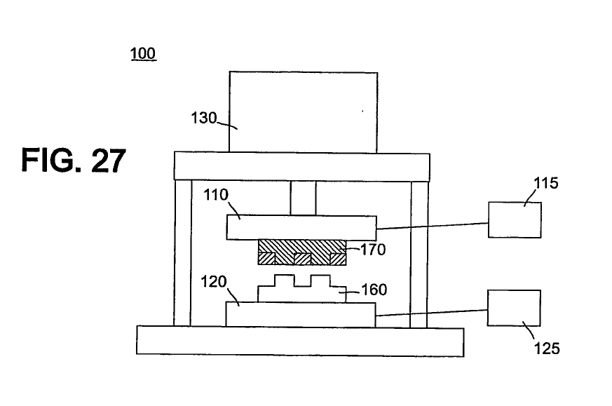

Furthermore, the second die used for production of the second stage structure is arranged on the upper stage 110. A resin that forms the skeletal member is used to fill the second die. FIG. 27 is a schematic view that shows second die 170 filled with the resin arranged on the upper stage 110. The upper stage 110 arranged with second die 170 is lowered and the second die 170 is pressed onto structure 160. The resin inside the second die heated to a temperature above the glass transition temperature of the resin is fused with the structure 160; then, the temperature of the resin filled inside the second die 170 is reduced to a temperature below the glass transition temperature of the resin to solidify the structure 160 and the resin filled in the second die 170. Furthermore, the second die 170 is separated from the structure 160 to produce the second structure where a skeletal member and cavities are arranged at predetermined intervals in at least a uniaxial direction.

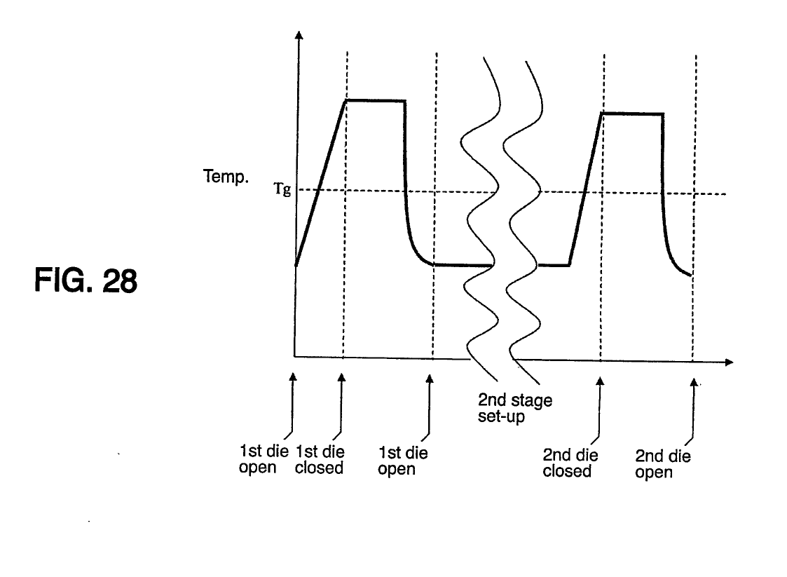

FIG. 28 shows the time-temperature chart of the resin at the time of production of the structure. Initially, the upper stage and the lower stage are opened and the first die is arranged on the upper stage. A resin base material arranged on the lower stage is heated to a temperature above the glass transition temperature of the resin using a temperature control means arranged on the upper stage and/or lower stage. Then, the first die is closed and retained as pressure is being applied to the resin for a pre-determined time so as to fill the resin in the recessed members of the first die. Subsequently, the temperature of the resin is reduced to a temperature below the glass transition temperature of the resin. When the first die is opened, a structure provided with a pattern according to the pattern of the die used is produced. Furthermore, the second die is arranged on the upper stage and the structure of the second stage is produced as explained above. The structure for the third stage on can be produced as explained above.

### EXAMPLES

The present invention is explained in further detail with respect to the following examples and comparative examples.

### Example 1

For the surface layer and back layer, a clear glass (Tᵥ=94%) with a thickness of 2 mm and size of 50 mm×10 mm was used. For the center layer, a structure of 20 laminated layers where rectangular-shaped skeletal members are arranged at pre-determined intervals was used. The material used for the skeletal member was poly(methyl methacrylate) (PMMA) and the pitch of the skeletal member was 300 nm, the width of the cavity was 150 nm and the height of the skeletal member was 300 nm.

The center layer was produced using a nano-imprinting method. As for the temperature condition used upon production of the center layer, the first die was closed and a temperature of 150° C. was used at the time of filling the first die with PMMA. Furthermore, the pressure applied when the first die was closed was 100 MPa.

Furthermore, PMMA was dissolved in dimethyl ketone and the PMMA was used to fill the second die using a spin coating process and the dimethyl ketone was subsequently evaporated. Using the die filled with the resin, the second die was pressed onto the structure produced by the first die. In the same manner, a center layer having a 20-layer laminated skeletal member was produced.

A liquid crystal (5CB) was filled into the cavity of the center layer to produce a light-control material. In order to evaluate the light-control performance, the temperature condition was changed and an evaluation was done at a temperature of 25° C. and 40° C., significant changes in reflectivity and transmittance were observed. And the results obtained are shown in Table IA and IB below.

TABLE IA
Stimulation OFF

| | | Reflec- | | % Trans- | Trans- |
|---|---|---|---|---|---|
| | | tance | Reflect. | mitted | mit. |
| | Stimulation | (600 nm) | (Rᵥ) | (600 nm) | (Tᵥ) |
| Example 1 | Temp. 25° C. | 8 | 8 | 86 | 89 |
| Example 2 | Voltage 0 V | 10 | 9 | 75 | 77 |
| Example 3 | Voltage 0 V | 10 | 8 | 73 | 76 |
| Comparative | Voltage 0 V | 8 | 8 | 50 | 56 |
| Example 1 | | | | | |
| Comparative | Voltage 0 V | 8 | 8 | 75 | 76 |
| Example 2 | | | | | |

TABLE IB
Stimulation ON

| | | Reflec- | | % Trans- | Trans- |
|---|---|---|---|---|---|
| | | tance | Reflect. | mitted | mit. |
| | Stimulation | (600 nm) | (Rᵥ) | (600 nm) | (Tv) |
| Example 1 | Temp. 35° C. | 56 | 11 | 40 | 80 |
| Example 2 | Voltage 60 V | 61 | 13 | 35 | 79 |
| Example 3 | Voltage 60 V | 60 | 73 | 33 | 21 |
| Comparative | Voltage 100 V | 8 | 9 | 75 | 74 |
| Example 1 | | | | | |
| Comparative | Voltage 60 V | 9 | 9 | 80 | 80 |
| Example 2 | | | | | |

### Example 2

For the surface layer and back layer, an indium tin oxide (ITO) deposited glass (Tᵥ=79%) with a thickness of 2 mm was used and a light-control material was produced as in Example 1. For stimulation of light-control, when a DC voltage of 60 V was applied to the electrode of the surface layer and back layer, a change in the arrangement in liquid crystal was observed and changes in reflectivity and in transmittance were observed.

### Example 3

For the surface layer and back layer, an ITO-deposited glass (Transverse transmission=79%) with a thickness of 2 mm was used. For the center layer, a three-layer laminate of a 20-layer laminated structure where rectangular-shaped skeletal members were arranged at pre-determined intervals was used. For the first structure, a 20-layer laminate where a structure having a skeletal member pitch of 300 nm, width of the cavity of 150 nm, and the height of the skeletal member of 300 nm was used. In the second 20-layer laminate structure, a structure having a skeletal member pitch of 250 nm, width of the cavity of 125 nm, and height of the skeletal member of 250 nm was used. For the third 20-layer laminate structure, a structure having a skeletal member pitch of 200 nm, width of the cavity of 100 nm, and the height of the skeletal member of 200 nm was used. In other words, a total of 60 laminate layers were used. The material used for the skeletal member was PMMA. Furthermore, the condition used for the nano-imprinting process was substantially the same as the case of Working Example 1 above, except that the size of the skeletal member and the number of laminate layers were changed as described above. For stimulation of light-control, when a DC voltage of 60 V was applied to the electrode of surface layer and back layer, a change in the arrangement in liquid crystal was observed and changes in reflectivity and transmittance were observed. In this case, the increase in reflectivity was significant.

### Comparative Example 1

A light-control material having a center layer where a liquid crystal is used to fill spherical cavities arranged at random (product of Japan Sheet Glass Co., Ltd.: UMU) was used and a comparison was made. For stimulation of light-control, the temperature condition was changed but no significant change was observed. Furthermore, for stimulation of light-control, when a DC voltage of 100 V was applied to the electrodes of surface layer and back layer, a change in the arrangement state and in transmittance and scattering was confirmed but a significant change in reflectivity was absent.

### Comparative Example 2

A three-dimensional structure having a plane with random structural arrangement was produced by a nano-imprinting process and a liquid crystal was used to fill the cavity and a light-control material was produced as in Example 2 above. For stimulation of light-control, the temperature condition was changed but no significant change was observed. Furthermore, for stimulation of light-control, when a DC voltage of 60 V was applied to the electrodes of the surface layer and back layer, a change in the arrangement state and in transmittance and scattering was confirmed but a significant change in reflectivity was absent.

### Evaluation of Optical Properties

Evaluation of optical properties was done according to the methods described below. Visible light transmittance (Tᵥ), visible light reflectivity (Rᵥ), and solar radiation transmittance (Tₑ) were evaluated by a spectrophotometer (product of Hitachi Co., Ltd. U-4000) according to the specifications of JIS R3106. It should be noted that the evaluation temperature used in the present specification was 25° C. in all cases unless otherwise specified.

### Example 4

The light-control material produced in the working example 3 was installed as the windshield of a Nissan Skyline V35™ and an evaluation of the vehicle temperature was made. The results obtained are shown in Table II below.

TABLE II

| | OFF time | ON time |
|---|---|---|
| Example 4 | 67° C. | 45° C. |
| Comparative Example 3 | 67° C. | 68° C. |

### Comparative Example 3

The light-control material produced in the Comparative Example 1 was installed as the windshield of a Nissan Skyline V35 and an evaluation of the vehicle temperature was made. The results obtained are shown in Table II above.

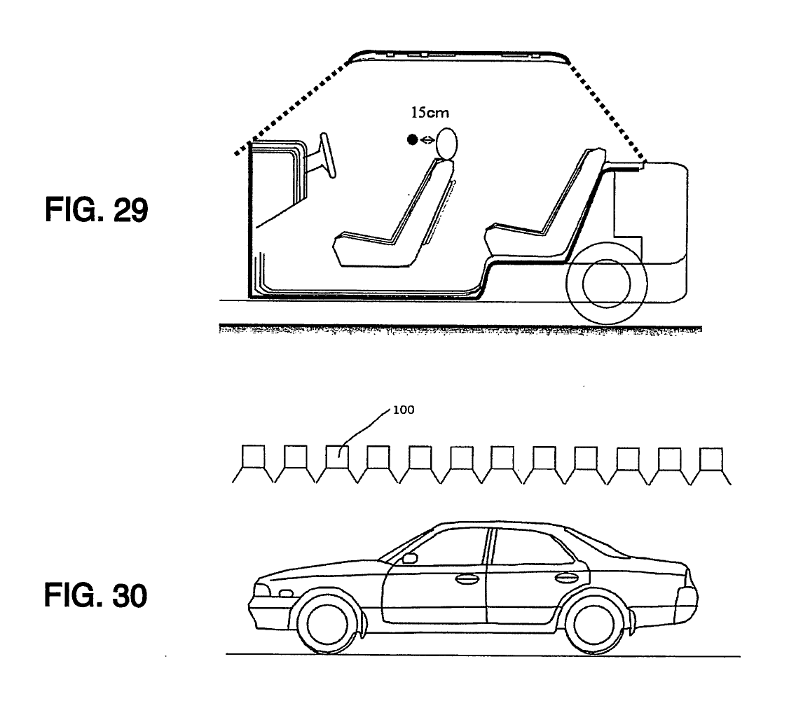

FIG. 29 is a perspective view that shows the position of the temperature measured in the temperature test. FIG. 30 is a schematic view of the device used for evaluation of temperature inside a vehicle under intense sunlight. The quantity of sunshine based on the solar lamp 100 simulates intense sunshine during the summer months and was set at 1000 W/m². The temperature at or near the head of the driver of the vehicle (approximately 15 cm forward from the head rest, see FIG. 29 for reference) was measured by a hygrothermometer (HMP233LD, available from Vycera Co.) using a K type thermocouple. It should be noted that the temperature outside the vehicle was set at 35° C. and the temperature 2 hours after started heating with the solar lamp 100 was used.

As shown in Table II above, it is possible to switch the optical function based on stimulation frequency and duration of the ON-OFF cycle of the LC optical element in the examples of the present disclosure. Furthermore, when a laminated structure is used where two or more center layers are laminated, a reduction in transmittance and an increase in reflectivity are suggested (see Example 3 for reference). Based on the results of the temperature test shown in Table II, it is apparent that the light-control glazing material of the present invention has the effect of reducing the interior temperature of a vehicle exposed to sunlight, compared to conventional window glazing materials.

The features are very effective especially when the light-control material of the present invention is used for the windshield of vehicles. When the light-control material of the present invention is applied as the windshield of a vehicle, sufficient transparency can be insured at the time of driving and furthermore, a reduction in transmittance as a result of an accident or malfunction can be prevented. And furthermore, solar energy entering the vehicle interior can be prevented and a comfortable compartment is provided for passengers and the load on the air conditioning system can be reduced. In addition, the present invention contributes to a reduction in fuel cost and a reduction in CO and CO₂ emissions as well.

Various embodiments of the invention have been described. These and other embodiments are within the scope of the following claims.

1. A light-control material, comprising in order, a surface layer oriented in a uniaxial direction, a center layer comprising a skeletal member and a plurality of cavities arranged at intervals and oriented parallel to the uniaxial direction of the surface layer, and a base layer.

2. The light control material of claim 1, further comprising a liquid crystal material at least partially filling the cavities.

3. The light control material of claim 1, wherein one or both of the surface layer and the base layer are substantially transparent to visible light.

4. The light-control material of claim 3, wherein the visible light transmittance of the liquid crystal material is at least about 70%.

5. The light-control material of claim 1, wherein each of the surface layer and the base layer comprise one or more electrodes adapted for application of an electrical potential to the liquid crystal material.

6. The light control material of claim 5, wherein the electrical potential is derived from an applied electric field oriented parallel to the uniaxial direction of the surface layer.

7. The light control material of claim 6, wherein the visible light transmittance of the liquid crystal material is at least about 70% when the electrical potential is applied to the electrodes.

8. The light-control material of claim 1, wherein each of the surface layer and the base layer comprise one or more of a glass or a resin.

9. The light-control material of claim 8, wherein each of the surface layer and the base layer comprise polymer films.

10. The light-control material of claim 8, wherein the surface layer comprises glass and the base layer comprises a polymer film.

11. The light-control material of claim 1, wherein the ratio of length:pitch of the cavities in the structure is in the range of about 1:1 to about 1:40.

12. The light-control material of claim 1, wherein the length of the cavity is in the range of about 50 to about 400 nanometers.

13. The light-control material of claim 1, wherein the width of the pitch is preferably in the range of about 100 to about 800 nanometers.

14. A method of manufacturing a light-control element, including:
providing a transparent surface layer oriented in an uniaxial direction, a center layer comprising a skeletal member, and a plurality of cavities arranged at intervals and oriented parallel to the uniaxial direction of the surface layer;
laminating the surface layer, the center layer and the cavities using a nano-imprinting method to form an optical structure;
laminating the optical structure a transparent base layer; and
adding a liquid crystal material to the cavities.

15. The method of claim 14, wherein the nano-imprinting method is selected from the group consisting of nano-embossing and radiation-cured nano-pattern imprinting.

16. The method of claim 15, wherein the radiation-cured nano-pattern imprinting is carried out using radiation selected from the group consisting of ultraviolet radiation, electron beam radiation, and infrared radiation.

17. The method of claim 14, wherein each of the surface layer and the base layer comprise materials including at least one resin.

18. The method of claim 17, wherein the resin is derived from a radiation curable chemical compound.

19. The method of claim 14, wherein lamination of the surface layer and the center layer to form an optical structure includes:
heating a first die to a temperature above the glass transition temperature of the base layer;
resin and pressing the first die against the base layer to fill the first die with the base layer material;
reducing the temperature of the first die to a temperature below the glass transition temperature of the base layer resin;
separating the base layer material from the die to form a plurality of cavities arranged at intervals on the base layer;
heating a second die to a temperature above the glass transition temperature of the surface layer resin, filling the second die with the surface layer resin and pressing the second die onto the base layer;
reducing the temperature of the second die to a temperature of below the glass transition temperature of the surface layer resin;
separating the second die from the surface layer resin to form an optical structure wherein the skeletal members and the cavities are arranged at pre-determined intervals and oriented in at least the uniaxial direction of the surface layer.

20. A light-control material, comprising:
a surface layer that transmits light;
a base layer that transmits light; the base layer being laid above the surface layer;
a liquid crystal that is arranged with one layer between the surface layer and the base layer; and
skeletal members that are arranged in the liquid crystal, the skeletal members being oriented parallel to the uniaxial direction of the surface layer so that cavities are formed between each skeletal member, wherein the skeletal members forms a lamination structure in the liquid crystal.

21. A light-control material according to claim 20, wherein a plurality of the lamination structure are formed with the skeletal members in the liquid crystal, the skeletal members arranged in one lamination structure have different uniaxial direction of the surface layer from the other skeletal members which are arrange in other lamination structure.

22. The light-control material of claim 20, wherein the light-control material comprises a vehicle window glazing.

23. The light-control material of claim 20, wherein the light-control material comprises a window glazing.
